(19) United States
(12) Patent Application Publication
(10) Pub. No.: US 2015/0126207 A1
(43) Pub. Date: May 7, 2015

(54) COEXISTENCE OF LTE OPERATED IN UNLICESNSED BAND

(71) Applicants: Zexian Li, Espoo (FI); Mikko Uusitalo, Helsinki (FI)

(72) Inventors: Zexian Li, Espoo (FI); Mikko Uusitalo, Helsinki (FI)

(73) Assignee: Nokia Corporation, Espoo (FI)

(21) Appl. No.: 14/397,488

(22) PCT Filed: May 31, 2012
(86) PCT No.: PCT/IB2012/052747

§ 371 Date: Jan. 8, 2015

(51) Int. Cl. H04W 72/08

(52) U.S. Cl. CPC H04W 72/082
USPC 455/452.1

(57) ABSTRACT

A cellular access node collects information about at least interference in a plurality of channels in unlicensed spectrum, and uses that collected information to update an allocation of the channels among at least two different access points APs. In one embodiment the information is collected from measurement reports received from each AP which indicates whether the various respective channels are available or reserved. Additional measurement reports may be collected from user equipments operating under the APs. In various embodiments the information can include channel recommendations, estimated capacity for the channels, and/or a traffic model for the channels. With this collected information the cellular access node can balance traffic among the APs by its channel allocation decisions. The non-limiting examples assume a radio environment where a LTE cellular access node operates a primary component carrier in licensed spectrum and the cooperating APs operate secondary component carriers in unlicensed spectrum.

### TECHNICAL FIELD

This invention relates generally to wireless communication, and more specifically relates to wireless radio operation on unlicensed spectrum in coordination with a network operator running licensed spectrum.

### BACKGROUND

This section is intended to provide a background or context to the invention that is recited in the claims. The description herein may include concepts that could be pursued, but are not necessarily ones that have been previously conceived, implemented or described. Therefore, unless otherwise indicated herein, what is described in this section is not prior art to the description and claims in this application and is not admitted to be prior art by inclusion in this section.

Release 10 of the evolved universal terrestrial radio access network (E-UTRAN, also known as long term evolution or LTE) operates with carrier aggregation, in which the whole system bandwidth is divided into multiple component carriers (CCs). FIG. 1A is an early rendition of the LTE carrier aggregation concept, in which the 100 MHz bandwidth is divided into five 20 MHz CCs each of which was backwards compatible with legacy Release 8. Each CC is sometimes referred to as a primary CC or a secondary CC, since Release 10 compatible user equipments (UEs) will be allocated one primary CC and possibly also one or more secondary CCs.

LTE-Advanced (LTE-A) is directed toward providing higher data rates at very low cost. One significant change is that LTE-A is to include bandwidth extensions beyond 20 MHz, for example aggregations of larger or smaller CCs than 20 MHz.

But these bandwidth extensions alone are not anticipated to meet future wireless needs; the amount of wireless traffic is forecast to increase by a factor of 1000 between 2010 and 2020. To cope with this burgeoning need, cellular operators are looking toward exploiting unlicensed radio spectrum for offloading traffic from their crowded licensed spectrum whenever practical. Unlicensed bands include what is known as the industrial, scientific and medical (ISM) band as well as television whitespaces (TV WS) which were once set aside for broadcast television in the United States. See for example the relevant references cited below.

There are two main scenarios for deploying LTE in the unlicensed band. In one case the unlicensed LTE is running alone, not unlike conventional WiFi wireless access networks (WLANs). The other case has the LTE cellular operator running two LTE network at the same time, one in the licensed band for wide coverage and one in the unlicensed band for data offloading. The latter scenario is relevant to these teachings.

In a carrier aggregation system such as LTE the unlicensed band can be designated as a secondary CC. Offloading data traffic to a secondary CC in the unlicensed band can potentially provide a very efficient way for having LTE operate in both licensed and unlicensed bands simultaneously. But this raises the issue of coexistence given the nature of the unlicensed band. These teachings are directed toward handling the coexistence issues when a cellular radio access technology such as LTE is operated over both licensed and unlicensed bands at the same time.

Relevant teachings in this regard may be seen at the following papers:
LICENSE-EXEMPT LTE SYSTEMS FOR SECONDARY SPECTRUM USAGE: SCENARIOS AND FIRST ASSESSMENT by Rahman, M. I.; Behravant, A.; Koorapaty, H.; Sachs, J.; and Balachandran, K. [2011 IEEE International Symposium on Dynamic Spectrum Access Networks, pp 349-358].
A FRAMEWORK FOR FEMTOCELLS TO ACCESS BOTH LICENSED AND UNLICENSED BANDS by Feilu Liu, Erdem Balay, Elza Erkip and Rui Yangy [Interdigital Communications; undated].
A DYNAMIC SPECTRUM ACCESS SCHEME FOR UNLICENSED SYSTEMS COEXISTING WITH PRIMARY OFDMA SYSTEMS by Pham, H. N.; Gronsund, P. I.; Engelstad, P. E.; and Grondalen, O. [2010 7^{th} IEEE Consumer Communications and Networking Conference, pp 1-5].

### BRIEF DESCRIPTION OF THE DRAWINGS

FIG. 1A is a schematic diagram of an early version of carrier aggregation for the LTE radio access technology, in which five component carrier bandwidths are aggregated into a single system bandwidth.

FIG. 1B is a schematic diagram of a radio environment in which embodiments of these teachings may be practiced to advantage.

FIG. 2 is an exemplary signaling diagram between a LTE AP operating in an unlicensed secondary) component carrier and a LTE eNB operating in a licensed component carrier according to a non-limiting embodiment of these teachings.

FIG. 3 is a logic flow diagram that illustrates from the perspective of a network access node the operation of a method, and a result of execution by an apparatus of a set of computer program instructions embodied on a computer readable memory, in accordance with the exemplary embodiments of this invention.

FIG. 4 is a simplified block diagram of a user equipment and an E-UTRAN eNB access node and an access point operating in cooperation with the cellular access node, all of which are exemplary devices suitable for use in practicing the exemplary embodiments of the invention.

### SUMMARY

In a first exemplary aspect of the invention there is a method which includes: collecting at a cellular network node information about at least interference in a plurality of channels in unlicensed spectrum; and using the collected information to update an allocation of the channels among at least two different access points.

In a second exemplary aspect of the invention there is an apparatus which includes at least one processor and at least one memory including computer program code. The at least one memory and the computer program code are configured, with the at least one processor and in response to execution of the computer program code, to cause the apparatus to perform: collecting information about at least interference in a plurality of channels in unlicensed spectrum; and using the collected information to update an allocation of the channels among at least two different access points.

In a third exemplary aspect of the invention there is a computer readable memory storing a program of instructions comprising: code for collecting information about at least interference in a plurality of channels in unlicensed spectrum; and code for using the collected information to update an allocation of the channels among at least two different access points.

In a fourth exemplary aspect of the invention there is an apparatus which includes means for collecting information about at least interference in a plurality of channels in unlicensed spectrum; and means for using the collected information to update an allocation of the channels among at least two different access points.

### DETAILED DESCRIPTION

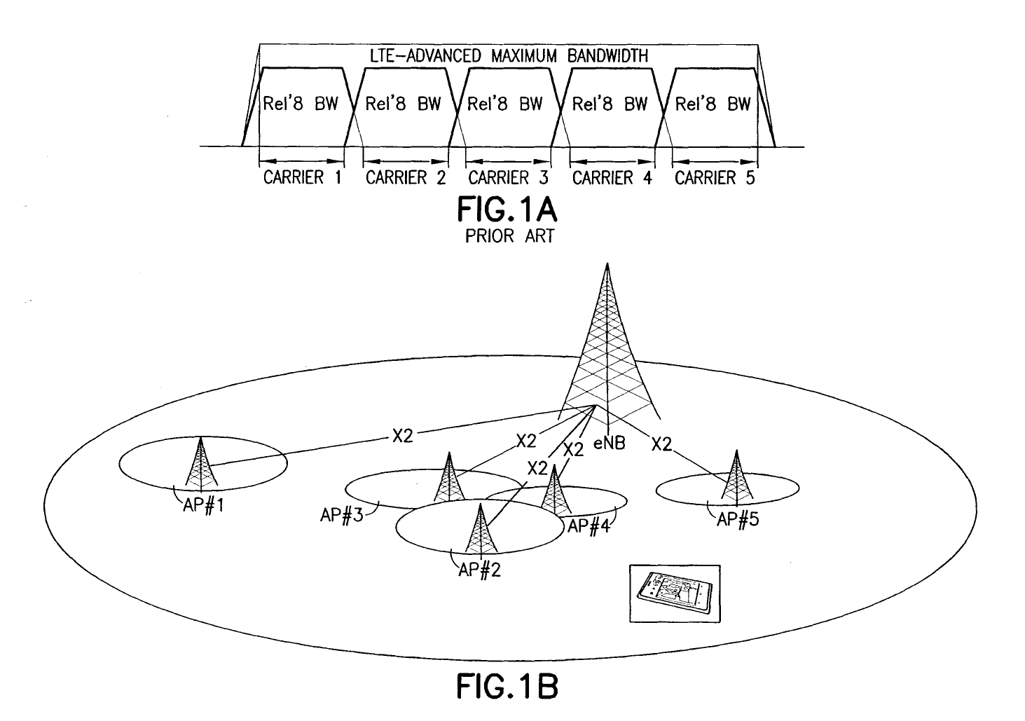

When operating in the unlicensed band, coexistence between unlicensed systems is one issue to be solved. The conventional WiFi/WLAN systems use a type of operation called carrier sense multiple access with collision detection (CSMA/CD) in which once a collision is detected the detecting entity terminates its transmissions so as to avoid secondary collisions. This might be suitable for a standalone access point (AP) operating with IEEE 802.11 or LTE radio access technology, for example AP#1 and AP#5 shown at FIG. 1B. But if the unlicensed band is operated by or in coordination with a network operator in the licensed band, there is an opportunity for a better exchange of information so as to construct a more effective coexistence arrangement with the AP(s) operating in the unlicensed band.

FIG. 1B is a schematic diagram showing an exemplary radio environment or deployment scenario in which these teachings may be practiced to advantage. There is one access node (eNB) operating in the licensed band, and five other access nodes (APs) each operating in the unlicensed band. For simplicity of the detailed explanation to follow assume all six access nodes are utilizing the LTE radio access technology. In other deployments the APs may for example utilize any of the various IEEE 802.11 family of radio standards for implementing wireless local area networks (WLANs) in the unlicensed band. In the LTE-only deployment there is an X2 interface between the eNB and each of the APs for exchanging control information and user data going to and from the UEs and their respective APs. In one example the same operator of the eNB is also operating the APs, and in another example there are different operators who are all cooperating according to these teachings to facilitate coexistence. Neither operational model has an effect on how these teachings are implemented. For either model the network operator will have clear knowledge of the geographic location of the LTE APs, which for brevity may be referred to as a geographical map. For simplicity in the following description but without limiting these teachings, the specific examples below assume the former model above, that the same operator runs both the eNB operating in the licensed band (termed the LTE eNB) and the relevant APs (each termed an LTE AP) operating in the unlicensed band.

There is little if any potential for interference between the LTE eNB and any of the LTE APs due to the frequency disparity between them. But considering that the darkened shaded areas surrounding the various APs represent the area of their respective coverage, the potential exists for collisions in the unlicensed band between wireless signals to and from AP#2, AP#3 and AP#4.

Another coexistence issue arises from the nature of the unlicensed band itself; being unlicensed the network operator has no control over other radios which are attached neither to the LTE eNB nor to any of the LTE APs. Some other AP not associated with the LTE eNB might be operating in the same geographic area and serving its own stations on the same unlicensed frequencies. The LTE eNB and its LTE APs will have no knowledge of those transmissions beforehand, absent some commonly adopted protocol such as listen-before-talk or request-to-send and clear-to-send messaging which these teachings do not assume (but which are compatible with these teachings). The examples below enhance the LTE eNB's opportunities to offload traffic to the unlicensed band via its own LTE APs, without degradation of performance or at least with minimal degradation for the offloaded traffic.

One characteristic common throughout these teachings is that the local area LTE APs are utilized for active feedback concerning the status of the unlicensed band. It is through this feedback that the LTE APs aid in the network operator's management of offloading traffic from the LTE eNB and from the licensed band. The LTE eNB uses this feedback reported to it by the LTE APs, and in some embodiments also by the UEs which are operating with the LTE APs in the unlicensed band, to manage the spectrum usage among LTE APs which have overlapping coverage such as AP#2, AP#3 and AP#4 in FIG. 1B.

One UE is shown at FIG. 1B by example as being within the coverage area of the LTE eNB. The UEs noted above which can participate in the active feedback would instead be located within the coverage area of any of the LTE APs. Such a UE is assumed to have a radio connection with its respective LTE AP in the unlicensed band and also with the LTE eNB in the licensed band. That dual coverage may be simultaneous in which case the UE will have (at least) two radio frequency (RF) chains or the dual coverage may be time division multiplexed between the licensed and unlicensed bands in which case the UE may have only one radio.

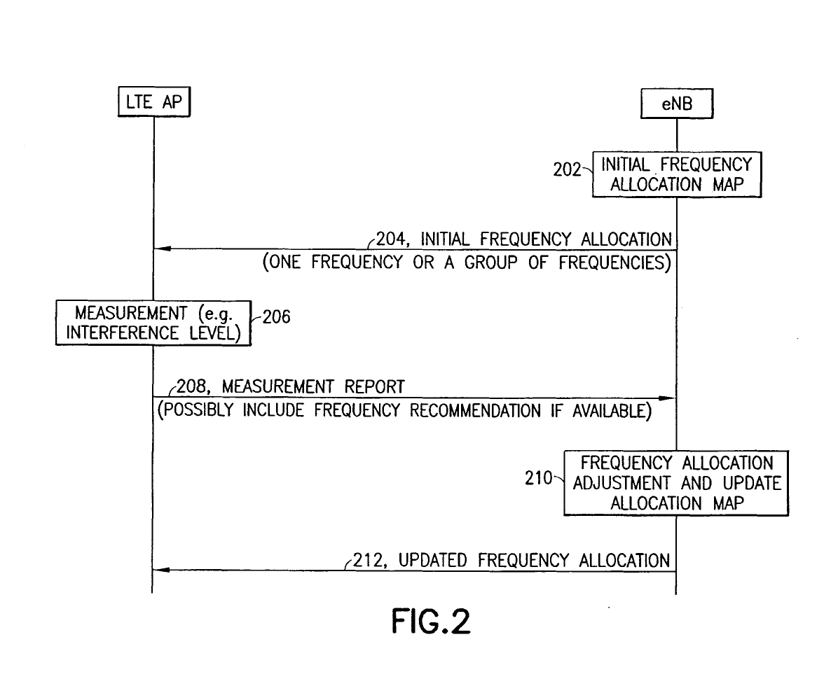

Firstly, the LTE eNB operating in the licensed band can be used to distribute frequency allocation information for the unlicensed band to the different LTE APs, such as via the X2 interface noted for FIG. 1B. The LTE eNB has a geographic map with the locations of all the LTE APs under its control and uses this information at block 202 of the FIG. 2 signaling diagram in making its initial frequency allocation. Since in this description there is not yet any feedback, consider this an initial frequency allocation, which the LTE eNB communicates to the various LTE APs at message 204 of FIG. 2. FIG. 2 shows only one LTE AP but the LTE eNB sends similar allocation messages to the others. So for example the LTE eNB will divide the unlicensed band into carriers and allocate different (frequency distinct) carriers to those LTE APs whose geographic locations are close to one another. In FIG. 1B LTE AP#2, AP#3 and AP#4 have overlapped coverage areas, so for example the LTE eNB can initially allocate carrier 1 for LTE AP #2, carrier 2 for LTE AP #3 and carrier 3 for LTE AP #4.

Or in another example the LTE eNB can, if available, allocate a group of frequencies to one LTE AP, for example, carriers 1-4 to LTE #2, carriers 5-8 to LTE AP #3 and carriers 9-12 for LTE AP #4. In an exemplary embodiment the LTE eNB will in this frequency allocation indicate the priority of the different frequencies for each LTE AP to minimize the possible interference among different LTE APs. One criterion by which the LTE eNB establishes these priorities can be maximizing the frequency distance. So for example if carriers 4 and 5 are nearest to one another for the above allocation to LTE AP#2 and AP#3, this criterion would tend to reduce the priority of those carriers. As will be seen, these priorities are dynamically updated.

Due to the dynamic nature of unlicensed frequencies, as noted above other conventional WiFi communications with other APs on the same frequency can arise without warning, the frequency allocation is in certain embodiments of these teachings is dynamically adjustable based on the measurements that the LTE eNB receives from the LTE APs. In this case of course the reporting LTE AP will be measuring the channel conditions at its allocated carriers, and in some embodiments will also be measuring and reporting on unallocated carriers. Collecting these measurements is shown for the LTE AP at block 206 of FIG. 2. If there is strong interference at some frequency, such as from some non-participating AP system (since within these teachings the eNB will be coordinating the frequency allocation with its participating LTE APs), the LTE AP would report this to the LTE eNB and the LTE eNB will re-assess that carrier's priority. Most likely that re-assessment in light of interference will put that carrier in a lower priority, or the carrier will be completed removed from the allocation list for at least that LTE AP reporting the interference. If the geographic map permits the LTE eNB may re-allocate that interfered carrier to another LTE AP, so for example if LTE AP#1 reported interference on carrier 1 the LTE eNB may choose to remove carrier 1 from the allocation to LTE AP#1 and add it to the allocation for LTE AP#4 which is geographically far enough that WiFi interference at LTE AP#1 should not be a factor for LTE AP#4.

So as one example implementation of the FIG. 2 signaling diagram, the LTE eNB sends at message 204 an initial frequency allocation to the LTE APs. After receiving the initial allocation information, the LTE APs start to measure the interference level at block 206, at least at the allocated frequencies. In case the interference level is too high to operate, the LTE AP will then send feedback to the LTE eNB, in the form of a measurement report 208 at FIG. 2. Based on the feedback information from the illustrated LTE AP and from others, the LTE eNB will form the updated frequency allocation at block 210 and send that updated information at least to the affected LTE APs in message 212.

As noted above, the LTE AP will measure the frequencies which it is allocated. If the LTE AP has the capability of measuring frequencies outside of the allocation, the LTE AP can in an exemplary embodiment include a frequency recommendation or proposal in the measurement report 208 as well. With this information the LTE eNB can expand the list of available channels.

In another embodiment the measurement report 208 includes as well information or even a model of other user traffic, to facilitate the frequency allocation decision at the LTE eNB. In this embodiment this additional information or traffic model is not routinely included in the measurement report which typically gives the interference level and possibly also throughput. Other routine measurements can also be included in a typical measurement report 208. The traffic modeling data can be included for example upon request by the LTE eNB.

Whatever its content the measurements can be carried out periodically, or alternatively or additionally they may be based on some trigger criterion. For example, new measurements and a new non-periodic report may be an increased number of retransmissions over some predetermined threshold, an increased packet loss rate over a threshold, and the like.

In another embodiment the measurement report from the LTE AP indicates one or more preferences for the different frequencies it reports. Additionally or alternatively the measurement report 208 can indicate an estimated capacity which the LTE AP can handle on its allocated frequency bands, preferably on a per carrier basis if more than one carrier is allocated to the reporting LTE AP.

So in summary, the measurement report 208 from the LTE AP can in certain embodiments include, in addition to its normal measurement information about its actual measurement data, any one or more of the following:
Frequency recommendations in the order of priority with potential parameters proportional to the level of priority. In this case the LTE AP can signal its recommended priority based on any potential information it has collected itself or that it obtains from other devices in its environment.
Capacity estimation for each reported frequency channel which can be used for offloading decision and load control (detailed further below).
A model of other user traffic. Details of certain implementations of such a predicted traffic model may be seen at co-owned PCT Patent Application WO 2010/000762 filed on Apr. 7, 2010 (published as WO 2011/124938 on Oct. 13, 2011).

In addition to the measurement reports 206 from the LTE APs, the LTE eNB can also collect measurements from some of the UEs attached to those LTE APs. The LTE eNB can use this further UE measurement information to improve the accuracy of its adjusted allocation, but this additional UE information is not necessary to practice the broader aspects of these teachings. For example, a given UE can measure the channel conditions it sees at different unlicensed bands. In this embodiment the UE reports its measurement results for the unlicensed band on the licensed band to the LTE eNB directly, since the assumption is that the licensed band is the UE's primary CC and the unlicensed band is its secondary CC. Of course the UE can report its measurement results for the unlicensed band on the unlicensed band to the LTE AP as well. One clear advantage for including these UE measurements in the LTE eNB's computation of the allocation adjustment is that the interference level seen by the LTE AP may be different from that seen by the UE on the same frequency band and in the same geographic area, and so the different measurement perspective gives the LTE eNB a more precise view of the true channel conditions.

The LTE eNB can in one embodiment combine the measurement reports from the LTE AP and its UE(s) by having the UEs' measurement reports also classifying the channel as being either possible/available for transmission or having too much interference/not available. The UE measurements would count in the same way as those from the LTE AP do, towards the estimated congestion on a channel in the area of a particular LTE AP. However the weighting will in this embodiment be a bit different; the weighting factor applied to the UE measurement would reduce its impact (for example, by dividing the UE measurement by a constant multiplier). Whether weighted in this manner or some other, the LTE eNB can determine the availability of a certain channel at one of the LTE APs based on the information from both the LTE AP itself and from one or more of the UEs it serves.

The LTE eNB collects all of this data from the LTE APs with cooperate with it, and possibly also from some of the UEs, and does a frequency allocation adjustment and updates its allocation map at block 210 of FIG. 2. Specifically, the LTE eNB seeks to control the load on the various LTE APs to which it is offloading traffic since in the carrier aggregation scenario the unlicensed band is being used as a secondary CC. But note that this load control is only over those LTE APs which are in cooperation with the LTE eNB and which send it measurement reports; the LTE eNB has no control over other entities operating in the unlicensed band such as conventional WiFi APs utilizing IEEE 802.11 radio access technologies but not cooperating for coexistence purposes with the LTE eNB.

From all of the collected measurement information and recommendations the LTE eNB adjusts the frequency allocation and sends the new allocations to the LTE APs at message 212. As with the measurement report 208, the content of this update frequency allocation 212 varies across different embodiments and implementations. But apart from that message 212, the LTE eNB can also, from that same information it has collected, then build what might be termed a deployment MAP which lists the current unlicensed band allocation and share this deployment map information with other neighbor cells and/or with the mobility management entity (MME) for higher-level coordination at the LTE eNB cell edge with other LTE. eNBs that might also be practicing these teachings especially if the same LTE AP is connecting to multiple LTE eNBs.

Whether in the form of a deployment map the LTE eNB shares with other cellular-network entities or some other form, the LTE eNB can keep a table on the estimated congestion on each potential channel (such as for example the percentage of the observed times) when the channel in the unlicensed band has been observed or known to be unusable due to other traffic. The congestion estimation can be updated based on every LTE AP measurement feedback, so for example if a new observation/measurement report signals that a channel is not available or “reserved”, the congestion percentage for that channel is moved up by one step and vice versa if the indication tells that the channel is available or “free”.

If the interference for a particular channel is higher than a predetermined threshold, the LTE eNB marks that particular channel as fully congested and it will not be used until further information in later measurement reports move the congestion level below the threshold. The LTE eNB would then update its allocation 210 so as to allocate traffic on each potential channel in proportion of the estimated congestion.

If the measurement reports 208 indicates to the LTE AP some preference(s) for some certain frequency, that preferred frequency would then be allocated in the desired order of priority for that particular LTE AP, so long as it would not violate the procedure described above for congestion exceeding the threshold.

The LTE eNB can then base its final decision whether or not to offload traffic to a given LTE AP and unlicensed band channel based the information from all LTE APs, and from the UEs if they are also sending measurement reports. Thus the offloading strategy is decided at the system-wide level with better coexistence performance rather than only by looking at the status of only one LTE AP.

If available from the collected measurement reports 208, information or even a model of other user traffic can be included in the LTE eNB's frequency allocation update decisions 210. If such a traffic model is used, the LTE eNB would allocate traffic on each channel at the times with the highest expectation of the unlicensed band channel being free traffic. For example, the LTE eNB may use a dynamically tunable parameter which reflects how low of an expectation would not be tolerated and thus no traffic should be allocated.

Additionally or alternatively, the LTE eNB can use another parameter which reflects the capacity that can be offered in the different unlicensed channels. The capacity can be estimated based for example on packet deliver latency, number of retransmission, history of channel usage, and so forth. Since the LTE eNB has information on the capacity of each channel of a certain LTE AP, this information can be used in the LTE eNB's determination of how much traffic can be offloaded to a certain channel at a certain LTE AP.

To control the load of the local LTE APs, the LTE eNB can use the licensed frequencies as much as they are available for better quality of service (QoS) support. When additional capacity is needed, the LTE eNB could move some of its traffic to the unlicensed bands based on its need using the secondary CCs. In that event the load on the unlicensed band to be put on all the LTE APs then depends on the estimated congestion/capacity which the LTE eNB learns from the measurement reports as detailed above.

Once traffic is offloaded, if the LTE eNB learns of imitations from differences in the operational performance of the different LTE APs, the LTE eNB can take that into account when doing its load balancing and choosing channels and LTE APs to which to offload further traffic, putting the new load on higher performing APs in proportion to the differences in performance. If the LTE eNB would like to offer more capacity for some other purpose in the area of a particular LTE AP, the load of that LTE AP could then be balanced accordingly. The LTE eNB can utilize the capacity estimation in the measurement reports from the different LTE APs to better balance the load among licensed eNB and unlicensed LTE APs.

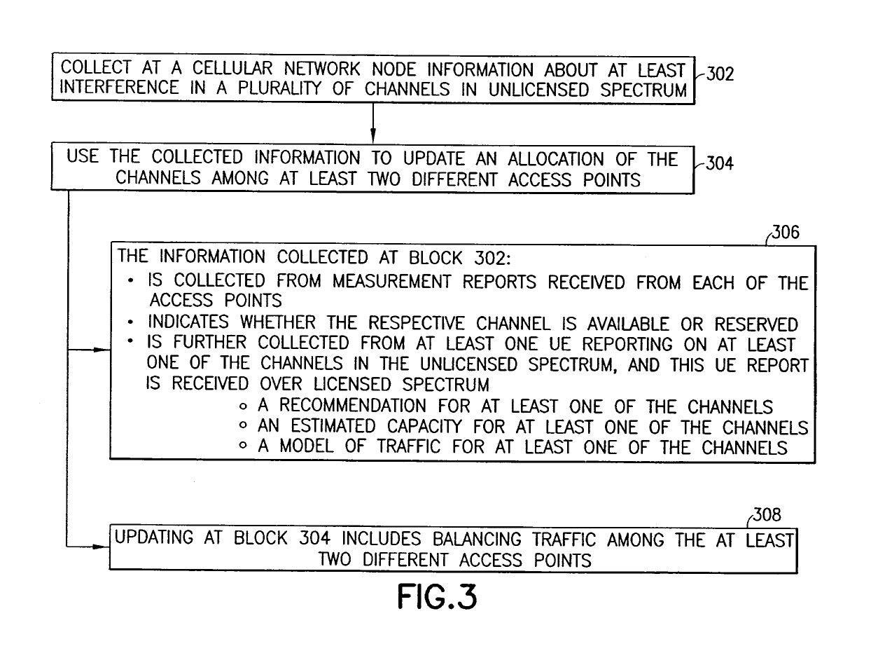

The logic flow diagram of FIG. 3 summarizes some of the various exemplary embodiments of the invention from the perspective of the cellular network node/LTE eNB (or certain components thereof if not performed by the entire eNB), and may be considered to illustrate the operation of a method, and a result of execution of a computer program stored in a computer readable memory, and a specific manner in which components of an electronic device are configured to cause that electronic device to operate, whether such an electronic device is the access node in full or one or more components thereof such as a modem, chipset, or the like.

FIG. 3 begins at block 302 where the LTE eNB or other cellular network node collects information about at least interference in a plurality of channels in unlicensed spectrum. Then at block 304 it uses the collected information to update an allocation of the channels among at least two different access points.

Further portions of FIG. 3 illustrate different ones of the above exemplary but non-limiting embodiments. Block 306 summarizes some of the above examples as to the information that is collected at block 302. Namely, in one embodiments the information is collected from measurement reports received from each of the access points; in another they also indicate whether the respective channel is available or reserved; in a still further embodiment there is also collected at least one further measurement report that the LTE eNB receives (directly) from a UE, and this UE based measurement report concerns at least one of the channels in the unlicensed spectrum yet is received by the LTE eNB over a wireless channel in licensed spectrum. And finally block 306 summarizes the embodiment in which the information collected at block 302 includes at least one of a) a recommendation for at least one of the channels; b) an estimated capacity for at least one of the channels; and e) a model of traffic for at least one of the channels.

Block 308 of FIG. 3 describes one further detail about how the information is sued at block 304 to update an allocation of the channels, namely to balance traffic among the at least two different access points.

The various blocks shown at FIG. 3 may be considered as a plurality of coupled logic circuit elements constructed to carry out the associated function(s), or specific result of strings of computer program code or instructions stored in a memory. Such blocks and the functions they represent are non-limiting examples, and may be practiced in various components such as integrated circuit chips and modules, and that the exemplary embodiments of this invention may be realized in an apparatus that is embodied as an integrated circuit. The integrated circuit, or circuits, may comprise circuitry (as well as possibly firmware) for embodying at least one or more of a data processor or data processors, a digital signal processor or processors, baseband circuitry and radio frequency circuitry that are configurable so as to operate in accordance with the exemplary embodiments of this invention.

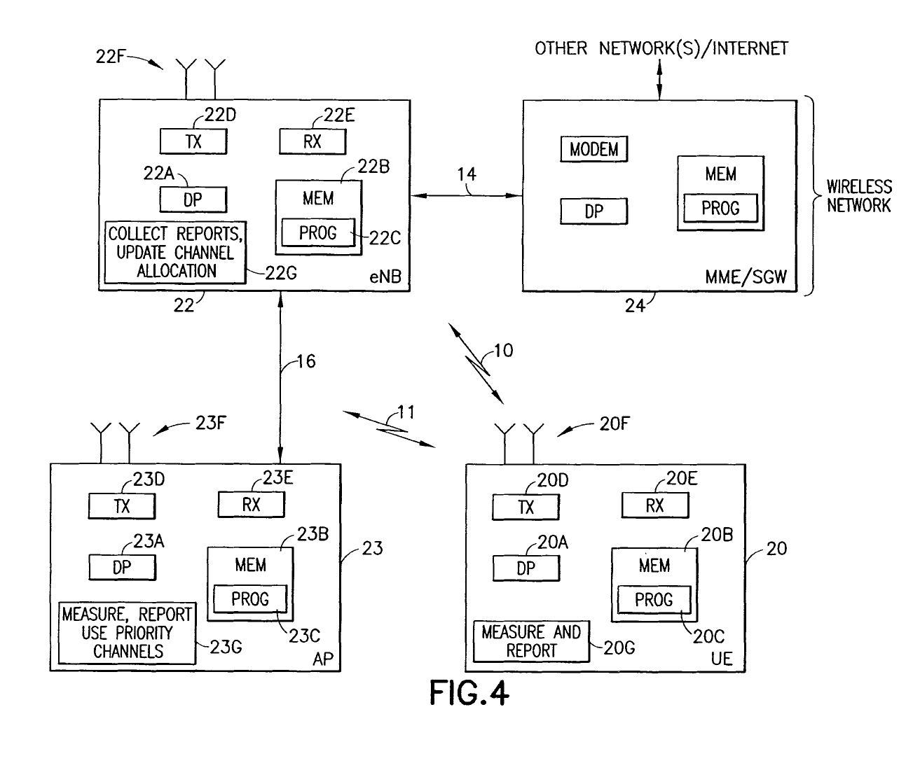

Reference is now made to FIG. 4 for illustrating a simplified block diagram of various electronic devices and apparatus that are suitable for use in practicing the exemplary embodiments of this invention. In FIG. 4 an eNB 22 is adapted for communication over a wireless link 10 with an apparatus, such as a mobile device/terminal such as a UE 20 and over a control/data link (such as an X2 link) with an AP 23. The UE 20 is also in wireless communication with the AP 23. While in embodiments of these teachings there are typically several APs in cooperation with the eNB 22, and several UEs under control of the eNB 22 and the AP 23, for simplicity only one AP 23 and one UE 20 is shown at FIG. 4. The eNB 22 may be any access node (including frequency selective repeaters or remote radio heads) of any wireless network such as LTE, LTE-A, GSM, GERAN, WCDMA, and the like. Similarly the AP 23 may be using any of those other exemplary radio access technologies on the unlicensed band, or it may be using non-cellular radio access technologies such as IEEE 802.11 for WLAN. The operator network of which the eNB 22 is a part may also include a network control element such as a mobility management entity MME and/or serving gateway SGW 24 or radio network controller RNC which provides connectivity with further networks (e.g., a publicly switched telephone network and/or a data communications network/Internet). The eNB 22 is coupled with the MME/SGW 24 via a control and data link 14.

The UE 20 includes processing means such as at least one data processor (DP) 20A, storing means such as at least one computer-readable memory (MEM) 20B storing at least one computer program (PROG) 20C or other set of executable instructions, communicating means such as at least one transmitter TX 20D and at least one receiver RX 20E for bidirectional wireless communications with the eNB 22 and the AP 23 via one or more antennas 20F. Also stored in the MEM 20B at reference number 20G is the UE's algorithm or function for measuring interference in the unlicensed band and reporting same to the eNB 22 directly on the licensed band as detailed further above, or alternatively on the unlicensed band.

The eNB 22 also includes processing means such as at least one data processor (DP) 22A, storing means such as at least one computer-readable memory (MEM) 22B storing at least one computer program (PROG) 22C or other set of executable instructions, and communicating means such as a transmitter TX 22D and a receiver RX 22E for bidirectional wireless communications with the UE 20 (or UEs) via one or more antennas 22F. The eNB's communication with the AP 23 is preferably over a wired or optical link but in some case may be a wireless RF backhaul link. The eNB 22 stores at block 22G the algorithm or function for collecting measurement reports from the AP 23 and from other APs, and in some embodiments also from the UE and from other UEs, and uses this collected information for making its allocation updates for the unlicensed channels. The eNB 22 then sends messages to the APs such as AP 23 with their new channel allocations and the priorities of those channels.

Similarly, the AP 23 includes its own processing means such as at least one data processor (DP) 23A, storing means such as at least one computer-readable memory (MEM) 23B storing at least one computer program (PROG) 23C or other set of executable instructions, and communicating means such as a transmitter TX 23D and a receiver RX 23E for bidirectional wireless communications via wireless link 11 with the UE 20 (or UEs) via one or more antennas 23F and further communication means for exchanging information with the eNB 20. The AP 23 stores at block 23G the algorithm or function for measurement the unlicensed band channels it has been allocated, and in some embodiments also other unlicensed band channels that it has not been allocated, and for compiling that information into measurement reports which it sends to the eNB 20 over link 16. The AP 23 additionally updates its list of allocated channels upon receiving from the eNB 22 a new channel allocation of channels in the unlicensed band.

At least one of the PROGs 22C/22G/23C/23G in the eNB 22 and in the AP 23 is assumed to include a set of program instructions that, when executed by the associated DP 22A/23A, enable the device to operate in accordance with the exemplary embodiments of this invention, as detailed above. The UE 20 also stores software 20C/20G in its MEM 20B to implement certain aspects of these teachings. In these regards the exemplary embodiments of this invention may be implemented at least in part by computer software stored on the MEM 20B, 22B, 23B which is executable by the DP 20A of the UE 20 and/or by the DP 22A of the eNB 22 and/or by the DP 23A of the AP 23, or by hardware, or by a combination of tangibly stored software and hardware (and tangibly stored firmware). Electronic devices implementing these aspects of the invention need not be the entire devices as depicted at FIG. 4 or may be one or more components of same such as the above described tangibly stored software, hardware, firmware and DP, or a system on a chip SOC or an application specific integrated circuit ASIC.

In general, the various embodiments of the UE 20 can include, but are not limited to personal portable digital devices having wireless communication capabilities, including but not limited to cellular telephones, navigation devices, laptop/palmtop/tablet computers, digital cameras and music devices, and Internet appliances. Embodiments of the eNB 22 and the AP 23 were noted above as a base station, remote radio head, etc.

Various embodiments of the computer readable MEMs 20B, 22B, 23B include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the DPs 20A, 22A, 23A include but are not limited to general purpose computers, special purpose computers, microprocessors, digital signal processors (DSPs) and multi-core processors.

Various modifications and adaptations to the foregoing exemplary embodiments of this invention may become apparent to those skilled in the relevant arts in view of the foregoing description. While the exemplary embodiments have been described above in the context of the LTE and LTE-A system, as noted above the exemplary embodiments of this invention may be used with various other types of wireless communication systems.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

1-21. (canceled)

22. A method comprising:
collecting at a cellular network node information about at least interference in a plurality of channels in unlicensed spectrum; and
using the collected information to update an allocation of the channels among at least two different access points.

23. The method according to claim 22, wherein the information is collected from measurement reports received from each of the access points.

24. The method according to claim 23, in which the measurement reports indicate whether the respective channel is available or reserved.

25. The method according to claim 23, in which the information is further collected from at least one further measurement report received from a user equipment reporting on at least one of the channels in the unlicensed spectrum, in which the further measurement report is received over a wireless channel in licensed spectrum.

26. The method according to claim 22, in which the information includes at least one of:
a recommendation for at least one of the channels;
an estimated capacity for at least one of the channels; and
a model of traffic for at least one of the channels.

27. The method according to claim 22, in which using the collected information to update an allocation of the channels comprises balancing traffic among the at least two different access points.

28. An apparatus comprising
at least one processor; and
at least one memory including computer program code;
the at least one memory and the computer program code is configured to, with the at least one processor, cause the apparatus to at least:
collect information about at least interference in a plurality of channels in unlicensed spectrum; and
use the collected information to update an allocation of the channels among at least two different access points.

29. The apparatus according to claim 28, wherein the information is collected from measurement reports received from each of the access points.

30. The apparatus according to claim 29, in which the measurement reports indicate whether the respective channel is available or reserved.

31. The apparatus according to claim 29, in which the information is further collected from at least one further measurement report received from a user equipment reporting on at least one of the channels in the unlicensed spectrum, in which the further measurement report is received over a wireless channel in licensed spectrum.

32. The apparatus according to claim 28, in which the information includes at least one of:
a recommendation for at least one of the channels;
an estimated capacity for at least one of the channels; and
a model of traffic for at least one of the channels.

33. The apparatus according to claim 28, in which using the collected information to update an allocation of the channels comprises balancing traffic among the at least two different access points.

34. The apparatus according to claim 28, in which the apparatus is a cellular access node.

35. A computer program product comprising a non-transitory computer-readable medium bearing computer program code embodied therein for use with a computer, the computer program code comprising:
code for collecting information about at least interference in a plurality of channels in unlicensed spectrum; and
code for using the collected information to update an allocation of the channels among at least two different access points.

36. The computer program product according to claim 35, wherein the information is collected from measurement reports received from each of the access points.

37. The computer program product according to claim 36, in which the measurement reports indicate whether the respective channel is available or reserved.

38. The computer program product according to claim 36, in which the information is further collected from at least one further measurement report received from a user equipment reporting on at least one of the channels in the unlicensed spectrum, in which the further measurement report is received over a wireless channel in licensed spectrum.

39. The computer program product according to claim 35, in which the information includes at least one of:
a recommendation for at least one of the channels;
an estimated capacity for at least one of the channels; and
a model of traffic for at least one of the channels.

40. The computer program product according to claim 35, in which using the collected information to update an allocation of the channels comprises balancing traffic among the at least two different access points.
